(19) United States
(12) Patent Application Publication
(10) Pub. No.: US 2009/0186975 A1
(43) Pub. Date: Jul. 23, 2009

(54) HARDENABLE EPOXY RESIN COMPOSITION

(75) Inventors: Stephane Schaal, Sierentz (FR); Cherif Ghoul, Mulhouse (FR); Vincent Tilliete, Zurich (CH); Francisco Arauzo, Zaragoza (ES); Patricia Gonzalez, Zaragoza (ES)

Correspondence Address: BUCHANAN, INGERSOLL & ROONEY PC, POST OFFICE BOX 1404, ALEXANDRIA, VA, 22313-1404, US

(73) Assignee: ABB Research Ltd., Zurich (CH)

(21) Appl. No.: 12/355,600

(22) Filed: Jan. 16, 2009

Related U.S. Application Data
(63) Continuation of application No. PCT/EP2007/056782, filed on Jul. 5, 2007.

(30) Foreign Application Priority Data
Jul. 20, 2006 (EP) 06405316.8

(51) Int. Cl. C08K 3/12

(52) U.S. Cl. 524/437

(57) ABSTRACT

A hardenable epoxy resin composition which is suitable for the production of an electrical insulation with improved thermal ageing properties, wherein said hardenable epoxy resin composition comprises an epoxy resin, a hardener, an inorganic filler composition, and a coupling agent for improving the bonding between the polymer matrix and the filler, and optionally further additives. The filler composition comprises silica and aluminum trihydride (ATH). The composition can be used for the production of an electrical insulation, and electrical articles containing such an electrical insulation system.

### RELATED APPLICATIONS

This application claims priority under 35 U.S.C. §119 to EP Application 06405316.8 filed in Europe on Jul. 20, 2006, and as a continuation application under 35 U.S.C. §120 to PCT/EP2007/056782 filed as an International Application on Jul. 5, 2007 designating the U.S., the entire contents of which are hereby incorporated by reference in their entireties.

### TECHNICAL FIELD

A hardenable epoxy resin composition is disclosed which is suitable for the production of an electrical insulation with improved thermal ageing properties. The present disclosure refers to a hardenable epoxy resin composition which is suitable to be used as an insulating resin for the production of an electrical insulation, especially in the field of impregnating electrical coils and in the production of electrical components such as transformers, bushings, insulators, switches, sensors, converters and cable end seals, particularly by using vacuum casting or automated pressure gelation (APG) manufacturing processes.

### BACKGROUND INFORMATION

Epoxy resin compositions are commonly used for the production of insulating materials for electrical applications. To improve the mechanical properties and also to reduce the costs, these epoxy resin compositions generally contain an inorganic filler. Silica flour is a preferred filler. The inorganic filler material can be mixed with aluminum trihydrate (ATH). However, the addition of ATH generally results in a significant impairment of the mechanical properties of the composition.

Epoxy resins present a number of advantages over other thermosetting polymers. Epoxy resins have generally a low price, are easy to process and have good dielectric and mechanical properties. Hardened epoxy resins, however, have generally a limited temperature stability. Today's market requires that electrical devices such as transformers have an increased overload capacity and an extended life time, combined sometimes with an increased resistance to fire. It is thus required that e.g. transformers are operated at higher temperatures and therefore, the insulation material must exhibit an improved temperature resistance. This problem is described for example in G. Pritchard, Developments in Reinforced Plastics, vol. 5, Applied Science (1986), where it is shown that epoxy resins are not suitable for applications at elevated temperatures.

### SUMMARY

A hardenable epoxy resin composition is disclosed which can be hardened to yield an electrical insulating material having a significantly improved thermal stability compared with known hardened epoxy resin compositions comprising a filler material, especially compared with silica-filled epoxy resin compositions. The epoxy resin composition according to the present disclosure further has a comparatively low viscosity and, therefore, can be processed using conventional vacuum casting and/or automated pressure gelation (APG) manufacturing processes. In the hardened state said composition shows no significant loss of mechanical properties compared with known hardened silica-filled epoxy resin compositions.

A hardenable epoxy resin composition is disclosed which is suitable for the production of an electrical insulation with improved thermal ageing properties, wherein said hardenable epoxy resin composition comprises an epoxy resin, a hardener, an inorganic filler composition, and a coupling agent for improving the bonding between the polymer matrix and the filler, and optionally further additives, wherein, i) the filler composition comprises silica and aluminum trihydride (ATH) at a ratio of silica:ATH from 10:1 to 1:10; (ii) the average particle size distribution of the silica is within the range of from 100 μm-0.5 μm; (iii) the average particle size distribution of ATH is below 10 μm, preferably within the range of from 10.0 μm-0.5 μm; and (iv) the filler composition is present in an amount within the range of 20-80% by weight, calculated to the total weight of the insulating composition, and wherein (v) the coupling agent is present preferably within the range of 0.1%-10% by weight, calculated to the total weight of the insulating composition.

Shaped articles are disclosed comprising the hardened epoxy resin composition in the form of an electrical insulation, such as electrical coils, of electrical components, preferably transformers, bushings, insulators, switches, sensors, converters and cable end seals, said articles having been made by using vacuum casting or automated pressure gelation (APG) manufacturing processes.

### DETAILED DESCRIPTION

It is known that silica filled epoxies perform better than ATH filled systems from a mechanical point of view. For a selected filler it is generally accepted that mechanical properties improve with decreasing filler particle size at a constant filler weight fraction, provided that a proper dispersion of the filler is achieved. However, the viscosity of the resin composition increases with decreasing filler particle size, so that conventional techniques such as vacuum casting or automated pressure gelation (APG) manufacturing processes cannot be used anymore for processing compositions which comprise a filler in the required quantity and wherein the filler has a comparatively low particle size distribution. To address this issue, processing aids such as commercially available organic copolymers containing acidic groups, such as Byk® W-9010 having an acid value of 129 mg KOH/g), have been developed to be added to the composition.

It has now been found that the substitution of a fraction of silica filler by ATH surprisingly, leads to a significant improvement of the thermal ageing properties. Therefore, by judiciously formulating the composition, one can obtain a mixture with mechanical and processing properties similar to conventional silica-filled epoxies but, simultaneously, with superior thermal ageing properties.

The present disclosure relates to a hardenable epoxy resin composition, i.e. a non-cured composition, which is suitable for the production of an electrical insulation with improved thermal ageing properties, wherein said hardenable epoxy resin composition comprises an epoxy resin, a hardener, an inorganic filler composition, and a coupling agent for improving the bonding between the polymer matrix and the filler, and optionally further additives, characterized in that,
(i) the filler composition comprises silica and aluminum trihydride (ATH) at a ratio of silica:ATH from 10:1 to 1:10;
(ii) the average particle size distribution of the silica is within the range of from 100 μm-0.5 μm;
(iii) the average particle size distribution of ATH is below 10 μm, preferably within the range of from 10.0 μm-0.5 μm; and
(iv) the filler composition is present in an amount within the range of 20-80% by weight, calculated to the total weight of the insulating composition, and wherein
(v) the coupling agent is present preferably within the range of 0.1%-10% by weight, calculated to the total weight of the insulating composition.

As optional additives the composition may comprise further at least a filler material which is different from silica and ATH, a curing agent (accelerant) for enhancing the polymerization of the epoxy resin with the hardener, at least a wetting/dispersing agent, at least one plasticizer, antioxidants, light absorbers, as well as further additives used in electrical applications.

The present disclosure further refers to the hardened epoxy resin composition in the form of electrical insulations as described herein before, having improved thermal ageing properties.

The present disclosure further refers to shaped articles comprising the hardened epoxy resin composition in the form of an electrical insulation, such as electrical coils as well as electrical components such as transformers, bushings, insulators, switches, sensors, converters and cable end seals, preferably said articles having been made by using vacuum casting or automated pressure gelation (APG) manufacturing processes.

The filler composition comprises silica mixed with aluminum trihydrate (ATH) at a ratio of silica:ATH from 10:1 to 1:10; preferably at a ratio from 5:1 to 1:5, preferably at a ratio of about 2:1 to 1:2, and most preferably at a ratio of about 1:1. The filler composition may further comprise a known inorganic filler which is different from silica and ATH in a weight ration of up to 50% by weight, preferably up to 30% by weight, and preferably up to 15% by weight, calculated to the weight of the ATH present. However, most preferred is that no inorganic filler which is different from silica and ATH is present.

The average particle size distribution of silica and of said optional filler which is different from silica and ATH is preferably within the range of from 100 μm-5 μm; preferably within the range of from 50 μm-5 μm, and preferably at about 10 μm. Preferably at least 70% of the particles, preferably at least 80% of the particles, and preferably at least 90% of the particles have a particle size within the range indicated.

The average particle size distribution of ATH is preferably within the range of from about 5.0 μm-0.5 μm; and preferably within the range of from about 4.0 μm-1.0 μm. Preferably at least 70% of the particles, preferably at least 80% of the particles, and preferably at least 90% of the particles have a particle size within the range indicated.

The filler composition is present in an amount within the range of 20-80% by weight, preferably within the range of 40-70% by weight, and preferably within the range of 50-65% by weight, calculated to the total weight of the insulating composition.

The coupling agent for improving the bonding between the polymer matrix and the filler can be selected from the group comprising silanes, siloxanes, titanate compounds, zirconate compounds, aluminate compounds, functionalized copolymers and organic acid-chromium chloride coordination complexes. Preferred are silanes and siloxanes. Most preferred are silanes.

The coupling agent is present preferably within the range of about 0.1%-10.0% by weight, preferably about 0.1%-4.0% by weight, preferably about 0.1%-2.0% by weight, and preferably within the range of about 0.4%-1.0% by weight, calculated to the total weight of the insulating composition.

The silane may be for example a trialkylsilane carrying a reactive group, such as a trimethylsilane; a dimethylphenylsilane or a phenyldimethylsilane; an alkoxysilane with one, two or three alkoxy groups carrying a reactive group, such as a methyldimethoxysilane, a trimethoxysilane. All said silanes carry a reactive group. Such preferred reactive groups are hydroxyl, hydrosilyl (to form ≡SiH), carboxyl, alkyl-epoxy, vinyl (to form ≡Si—CH═CH₂), allyl (to form ≡Si—CH₂—CH═CH₂) or an amine or an alkylene-amine group. Preferred is the alkyl-epoxy functionality. A preferred example is 3-glycidoxypropyltrimethoxysilane, as is commercially available under the trade name Dow Z-6040. Said reactive groups may react with the epoxy functionality of the epoxy resin or the functionality of the hardener, which for example may be a hydroxyl functionality or anhydride functionality. Such silanes correspond to the chemical formula (R)₃Si (reactive group)

wherein the reactive group has the meaning as given above and the substituent R is defined as described herein below.

The siloxane coupling agent is preferably selected from the group comprising polydimethylsiloxanes which preferably carry reactive groups, preferably selected from hydroxyl, hydrosilyl (to form ≡SiH), carboxyl, alkyl-epoxy, vinyl or allyl or an amine or an alkylene-amine group. Preferred is the alkyl-epoxy functionality.

Preferably the coupling agent comprises a compound, or a mixture of compounds, of the general formula (I) or formula (II):

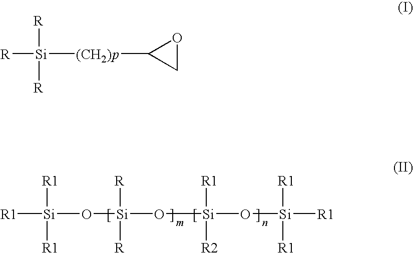

in which

R independently of each other is an optionally substituted alkyl radical having from 1 to 8 carbon atoms, (C₁-C₄-alkyl)aryl, or aryl; or an alkoxy radical having from 1-8 carbon atoms;

R₁, independently at each occurrence has one of the definitions of R or R₂, it being possible for two terminal substituents R₁, attached to different Si atoms, being taken together to be an oxygen atom (=cyclic compound);
p is 1, 2, 3 or 4, preferably 1 or 2;
R₂ has one of the definitions of R, or is hydrogen, hydroxyalkyl or —CH₂—[CH—CH₂(O)] or —(CH₂)₂—[CH—CH₂(O)]; vinyl or allyl; —NH₂ or —(CH₂)ₚNH₂; preferably —CH₂—[CH—CH₂(O)] or —(CH₂)₂—[CH—CH₂(O)];
m is on average from zero to 5000;
n is on average from one to 100;
   the sum of [m+n] for non-cyclic compounds being at least 20, and the sequence of the groups —[Si(R)(R)O]— and —[Si(R₁)(R₂)O]— in the molecule being arbitrary.

In the above definition of R₂ the rest [—CH—CH₂(O)] stands for glycidyl [formula (III)]:

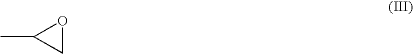

Preferred is the compound of the formula (I), wherein R is methyl or methoxy and p is 1 or 2, preferably 1. Examples are 3-glycidoxypropyltrimethoxysilane or 3-glycidoxypropyldimethoxymethylsilane.

Preferred is the compound of the formula (II), wherein R independently of each other is an unsubstituted alkyl radical having from 1 to 4 carbon atoms or phenyl, preferably methyl; R₂ is —CH₂—[CH—CH₂(O)] or —(CH₂)₂—[CH—CH₂(O)]; m is on average from 20 to 5000, preferably 20 to 100; n is on average from 2 to 50, preferably 2 to 10; the sum of [m+n] for non-cyclic compounds being on average in the range from 22 to 5000, preferably 22 to 100, and the sequence of the groups —[Si(R)(R)O]— and —[Si(R₁)(R₂)O]— in the molecule being arbitrary.

Preferred cyclic compounds of formula (II) are those comprising 4-12, and preferably 4-8, —[Si(R)(R)O]— units or —[Si(R₁)(R₂)O]— units or a mixture of these units, and preferably wherein the compound contains at least one —[Si (R₁)(R₂)O]— units wherein R₂ is —CH₂—[CH—CH₂(O)] or —(CH₂)₂—[CH—CH₂(O)].

The filler composition comprises silica and aluminum trihydrate (ATH) and may optionally comprise an inorganic filler which is different from silica and aluminum trihydrate (ATH). Aluminium hydroxide [Al(OH)₃] is often referred to as Aluminium trihydrate [(ATH), (Al₂O₃.3H₂O)] because chemically (Al₂O₃.3H₂O) corresponds to 2[Al(OH)₃]. However, the term aluminum trihydrate (ATH) is generally used.

Titanate coupling compounds are for example monoalkoxy titanate, chelate titanate, quad titanate, neoalkoxy titanate, coordinate titanate, such compounds being commercially available e.g. as Dupont Tyzor, TPT, TBT, TOT, Kenrich LICA 38®; zirconate compounds are for example zircoaluminate, zirconium proprionate, neoalkoxy zirconate, ammonium zirconium carbonate, such compounds being commercially available e.g. as Dupont Tyzor, Manchem CPG®; aluminate compounds are for example alkylaceto-acetate aluminum di-isopropylate, such compounds being commercially available e.g. Ajinomoto Plenact AL-M®; functionalized copolymers are for example epoxyxidized polyolefins copolymers, maleic anhydride grafted polyolefins, such compounds being are commercially available e.g. as Dupont Elvaloy, Fusabond®; organic acid-chromium chloride coordination complexes are for example chromium methacrylate monomers, such compound being commercially available e.g. as Dupont Volan®.

The filler composition may optionally further comprise at least one known inorganic filler which is different from silica and ATH. Such inorganic fillers are for example glass powder, metal oxides such as silicon oxide (e.g. Aerosil, quarz, fine quarz powder), magnesium hydroxide [Mg(OH)₂], titanium oxide; metal nitrides, such as silicon nitride, boron nitride and aluminium nitride; metal carbides, such as silicon carbide (SiC); metal carbonates (dolomite, CaC0₃), metal sulfates (e.g. baryte), ground natural and synthetic minerals mainly silicates, such as talcum, glimmer, kaolin, wollastonite, bentonite; calcium silicates such as xonolit [Ca₂Si₆O₁₇(OH)₂]; aluminium silicates such as andalusite [Al₂O₃.SiO₂] or zeolithe; calcium/magnesium carbonates such as dolomite [CaMg(CO₃)₂]; and known calcium/magnesium silicates, in different powder sizes.

Preferred fillers which are different from silica and ATH are aluminium oxide, xonolite, magnesium hydroxide, ground natural stones, ground natural minerals (e.g. in form of ground sand) and synthetic minerals derived from silicates.

The filler material, independently of each other, optionally may be present in a “porous” form. As a “porous” filler material, which optionally may be coated, it is understood, that the density of said filler material is within the range of 60% to 80%, compared to the “real” density of the non-porous filler material. Such porous filler materials have a much higher total surface than the non-porous material. Said surface preferably is higher than 20 m²/g (BET m²/g) and preferably higher than 30 m²/g (BET) and preferably is within the range of 30 m²/g (BET) to 300 m²/g (BET), preferably within the range of 40 m²/g (BET) to 60 m²/g (BET).

Preferred epoxy resins used within the context of the present disclosure are aromatic and/or cycloaliphatic compounds. These compounds are known per se. Epoxy resins are reactive glycidyl compounds containing at least two 1,2-epoxy groups per molecule. Preferably a mixture of polyglycidyl compounds is used such as a mixture of diglycidyl- and triglycidyl compounds.

Epoxy compounds useful for the present disclosure comprise unsubstituted glycidyl groups and/or glycidyl groups substituted with methyl groups. These glycidyl compounds preferably have a molecular weight between 200 and 1200, especially between 200 and 1000 and may be solid or liquid. The epoxy value (equiv./100 g) is preferably at least three, preferably at least four and especially at about five, preferably about 4.9 to 5.1. Preferred are glycidyl compounds which have glycidyl ether- and/or glycidyl ester groups. Such a compound may also contain both kinds of glycidyl groups, e.g. 4-glycidyloxy-benzoic acidglycidyl ester. Preferred are polyglycidyl esters with 1-4 glycidyl ester groups, especially diglycidyl ester and/or triglycidyl esters. Preferred glycidyl esters may be derived from aromatic, araliphatic, cycloaliphatic, heterocyclic, heterocyclic-aliphatic or heterocyclic-aromatic dicarbonic acids with 6 to 20, preferably 6 to 12 ring carbon atoms or from aliphatic dicarbonic acids with 2 to 10 carbon atoms. Preferred are for example optionally substituted epoxy resins of formula (IV):

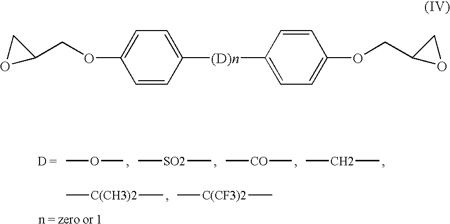

or formula (V):

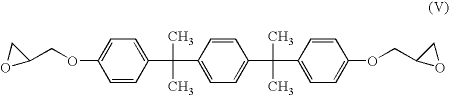

Examples are glycidyl ethers derived from Bisphenol A or Bisphenol F as well as glycidyl ethers derived from Phenol-Novolak-resins or cresol-Novolak-resins.

Cycloaliphatic epoxy resins are for example hexahydro-o-phthalic acid-bis-glycidyl ester, hexahydro-m-phthalic acid-bis-glycidyl ester or hexahydro-p-phthalic acid-bis-glycidyl ester. Also aliphatic epoxy resins, for example 1,4-butane-diol diglycidyl ether, may be used as a component for the composition of the present disclosure.

Preferred within the present disclosure are also aromatic and/or cycloaliphatic epoxy resins which contain at least one, preferably at least two, aminoglycidyl group in the molecule. Such epoxy resins are known and for example described in WO 99/67315. Preferred compounds are those of formula (VI):

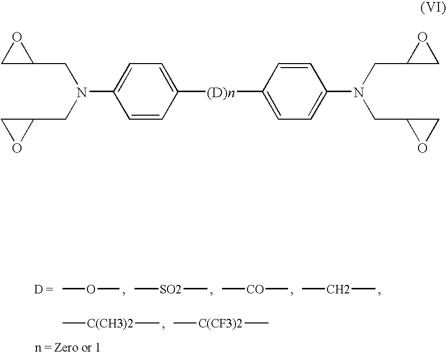

Especially suitable aminoglycidyl compounds are N,N-diglycidylaniline, N,N-diglycidyltoluidine, N,N,N′,N′-tetraglycidyl-1,3-diaminobenzene, N,N,N′,N′-tetraglycidyl-1,4-diaminobenzene, N,N,N′,N′-tetraglycidylxylylendiamine, N,N,N′,N′-tetraglycidyl-4,4′-diaminodiphenylmethane, N,N,N′,N′-tetraglycidyl-3,3′-diethyl-4,4′-diaminodiphenylmethane, N,N,N′,N′-tetraglycidyl-3,3′-diaminodiphenylsulfone, N,N′-Dimethyl-N,N′-diglycidyl-4,4′-diaminodiphenylmethane, N,N,N′,N′-tetraglycidyl-alfa,alfa′-bis(4-aminophenyl)-p-diisopropylbenzene and N,N,N′,N′-tetraglycidyl-alfa,alfa′-bis-(3,5-dimethyl-4-aminophenyl)-p-diisopropylbenzene.

Preferred aminoglycidyl compounds are also those of formula (VII):

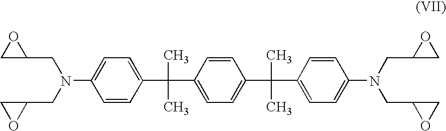

or of formula (VIII):

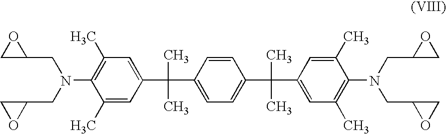

Further aminoglycidyl compounds which can be used according to the present disclosure are described in e.g. Houben-Weyl, Methoden der Organischen Chemie, Band E20, Makromolekulare Stoffe, Georg Thieme Verlag Stuttgart, 1987, pages 1926-1928.

Hardeners are known to be used in epoxy resins. Hardeners are for example hydroxyl and/or carboxyl containing polymers such as carboxyl terminated polyester and/or carboxyl containing acrylate- and/or methacrylate polymers and/or carboxylic acid anhydrides. Useful hardeners are further cyclic anhydrides of aromatic, aliphatic, cycloaliphatic and heterocyclic polycarbonic acids. Preferred anhydrides of aromatic polycarbonic acids are phthalic acid anhydride and substituted derivates thereof, benzene-1,2,4,5-tetracarbonic acid dianhydride and substituted derivates thereof. Numerous further hardeners are from the literature.

The optional hardener can be used in concentrations within the range of 0.2 to 1.2, equivalents of hardening groups present, e.g. one anhydride group per 1 epoxide equivalent. However, often a concentration within the range of 0.2 to 0.4, equivalents of hardening groups is preferred.

As optional additives the composition may comprise further at least a curing agent (accelerant) for enhancing the polymerization of the epoxy resin with the hardener, at least one wetting/dispersing agent, plasticizers, antioxidants, light absorbers, as well as further additives used in electrical applications.

Curing agents for enhancing the polymerization of the epoxy resin with the hardener are for example tertiary amines, such as benzyldimethylamine or amine-complexes such as complexes of tertiary amines with boron trichloride or boron trifluoride; urea derivatives, such as N-4-chlorophenyl-N′,N′-dimethylurea (Monuron); optionally substituted imidazoles such as imidazole or 2-phenyl-imidazole. Preferred are tertiary amines. Other curing catalyst such as transition metal complexes of cobalt (III), copper, manganese, (II), zinc in acetylacetonate may also be used, e.g. cobalt acetylacetonate (III). The amount of catalyst used is a concentration of about 50-1000 ppm by weight, calculated to the composition to be cured.

Wetting/dispersing agents are known per se for example in the form of surface activators; or reactive diluents, preferably epoxy-containing or hydroxyl-containing reactive diluents; thixotropic agents or resinous modifiers. Known reactive diluents for example are cresylglycidylether, diepoxyethyl-1,2-benzene, bisphenol A, bisphenol F and the diglycidylethers thereof, diepoxydes of glycols and of polyglycols, such as neopentylglycol-diglycidylether or trimethylolpropane-diglycidylether. Exemplary commercially available wetting/dispersing agents are for example organic copolymers containing acidic groups, e.g. Byk® W-9010 having an acid value of 129 mg KOH/g). Such Wetting/dispersing agents are preferably used in amounts of 0.5% to 1.0% based on the filler weight.

Plasticizers, antioxidants, light absorbers, as well as further additives used in electrical applications are known in the art and are not critical.

The insulating composition is made simply by mixing all the components, optionally under vacuum, in any desired sequence and curing the mixture by heating. The hardener and the curing agent can be separately added before curing. The curing temperature is preferably within the range of 50° C. to 280° C., preferably within the range of 100° C. to 200° C. Curing generally is possible also at lower temperatures, whereby at lower temperatures complete curing may last up to several days, depending also on catalyst present and its concentration.

The non-hardened insulating resin composition can be applied by using vacuum casting or automated pressure gelation (APG) manufacturing processes, optionally under the application of vacuum, to remove all moisture and air bubbles from the coil and the insulating composition. The encapsulating composition may then be cured by any method known in the art by heating the composition to the desired curing temperature.

Exemplary uses of the insulation produced according to the present disclosure are electrical insulations, especially in the field of impregnating electrical coils and in the production of electrical components such as transformers, bushings, insulators, switches, sensors, converters and cable end seals.

Exemplary uses of the insulation system produced according to the present disclosure are also high-voltage insulations for indoor and outdoor use, especially for outdoor insulators associated with high-voltage lines, as long-rod, composite and cap-type insulators, and also for base insulators in the medium-voltage sector, in the production of insulators associated with outdoor power switches, measuring transducers, lead-throughs, and overvoltage protectors, in switchgear construction, in power switches, dry-type transformers, and electrical machines, as coating materials for transistors and other semiconductor elements and/or to impregnate electrical components.

The present disclosure further refers to the electrical articles containing an electrical insulation system according to the present disclosure. The following examples illustrate the disclosure.

### Example 1

### Comparative Example, Influence of Particle Size

This Example illustrates the effect of ATH particle size. The problem encountered is that the reduction of the particle size causes a significant increase of the viscosity. To address this issue, a processing aid (Byk W-9010, a copolymer with acidic groups) was added. Consequently, fine grades of ATH together with the dispersing agent were used in order to compensate for the loss of mechanical properties. Materials filled with a mixture of ATH and W12 were compared to the silica filled reference. The results are listed in Table 1:

TABLE 1

| | Ingredients | Reference | Reference | Reference |
|---|---|---|---|---|
| | parts by | without ATH | 1 parts | 2 parts |
| | weight (b.w.) | parts b.w. | by weight | by weight |
| | EPR 845 | 100 | 100 | 100 |
| | Epoxy resin | | | |
| | EPH 845 | 82 | 82 | 82 |
| | Hardener | | | |
| | EPC 845 | 2 | 2 | 2 |
| | Curing agent | | | |
| | Wetting/ | — | 2 | 2 |
| | dispersing | | | |
| | agent, BYK-W | | | |
| | 9010 | | | |
| | Silica W12 | 320 | 160 | 160 |
| | ATH1 (7 μm) | — | 160 | — |
| | ATH2 (2 μm) | — | — | 160 |
| Results : | | | | |
| Steady state | η* [Pa · s] | 1.1 | 0.6 | 0.7 |
| dynamic viscos- | | | | |
| ity at 65° C. | | | | |
| | E [MPa] | 10384 | 10364 | 11628 |
| Flex. strength, | Rm [MPa] | 129 | 108 | 120 |
| ISO 178 | ε [%] | 1.40 | 1.12 | 1.12 |

η* [Pa · s] = complex dynamic viscosity;
E = Young's modulus in bending;
Rm = flexural strength;
ε = deformation at break.
EPR 845 epoxy resin, EHP 845 anhydride hardener and
EPC 845 curing agent are all supplied by Bakelite.
EPR 845: Bisphenol A/F based epoxy mixture
EPH 845: modified carboxylic acid anhydride
EPC 845: modified tertiary amine
BYK-W9010 is a wetting/dispersing agent supplied by Byk Chemie.
W12 is a silica flour supplied by Quarzwerke
ATH1 is Apyral 24 supplied by Nabaltec.
ATH2 is Martinal OL-104LE supplied by Martinswerk.

### Discussion of Results:

Effect on the viscosity: Both ATH filled formulations reported in Table 1 exhibited a lower viscosity than the Reference due to the addition of the processing aid. Without the processing aid, the viscosities were so high that vacuum casting or APG were impossible to implement. With finer particle size the viscosity of the ATH-filled formulation increases. The formulation Reference 2 filled with a 2 μm ATH exhibited a slightly higher viscosity than formulation Reference 1 filled with a 7 μm ATH.

Effect on mechanical properties: The formulation Reference 1 filled with ATH with an average particle size distribution of 7 μm exhibited much lower mechanical properties than the Reference. By comparing mechanical data of formulations Reference 1 and Reference 2, one concludes that using the fine average particle size ATH2 leads to improved mechanical properties compared to ATH1. The properties of formulation Reference 2 still remained lower than the reference.

### Example 2

### Effect of Silane and/or Siloxane Coupling Agent

Example 2 illustrates the effect of the silane coupling agent according to the present disclosure. The selected coupling agent was Dow Corning Z-6040, (an epoxy-silane: 3-glycidoxypropyltrimethoxysilane). Formulations with and without coupling agent are compared in Table 2.

TABLE 2

| | Ingredients | Reference | Reference | Reference |
|---|---|---|---|---|
| | parts by | without ATH | 2 parts | 3 parts |
| | weight (b.w.) | parts b.w. | by weight | by weight |
| | EPR 845 | 100 | 100 | 100 |
| | Epoxy resin | | | |
| | EPH 845 | 82 | 82 | 82 |
| | Hardener | | | |
| | EPC 845 | 2 | 2 | 2 |
| | Curing agent | | | |
| | Wetting/ | — | 2 | 2 |
| | dispersing | | | |
| | agent, BYK-W | | | |
| | 9010 | | | |
| | Dow Z-6040 | — | — | 2.5 |
| | Silica W12 | 320 | 160 | 160 |
| | ATH2 (2 μm) | — | 160 | 160 |
| Results: | | | | |
| Steady state | η* [Pa · s] | 1.1 | 0.7 | 0.5 |
| dynamic viscos- | | | | |
| ity at 65° C. | | | | |
| | E [MPa] | 10384 | 10628 | 10584 |
| Flex. strength, | Rm [MPa] | 129 | 120 | 130 |
| ISO 178 | ε [%] | 1.40 | 1.12 | 1.38 |
| Thermal aging | Time to | 130 | >1000 | >1000 |
| at 260° C. | failure | | | |
| IEC 60216-1 | (hours | | | |

### Discussion of Results:

Effect on the viscosity: The silane coupling agent (Dow Corning Z-6040) improves the compatibility of ATH with the matrix polymer and aids rapid and complete dispersion of the filler. A reduction in viscosity was measured, improving the ease of processing of formulation Reference 3 compared to Reference 2.

Effect on mechanical properties: The addition of the silane coupling agent clearly improves the mechanical properties of the materials. The formulation Reference 3 exhibits a 10% increase of flexural strength and a 20% increase of deformation at break compared to formulation Reference 2. The results reported in Table 2 demonstrate the effectiveness of having both: low particle size ATH and the silane coupling agent in the same material. Indeed, the mechanical properties exhibited by formulation Reference 3, combining ATH2 and coupling agent, are similar to the silica-filled reference.

Thermal ageing: Thermal ageing tests were carried out at 260° C. (according to the IEC 60216-1 standard) and compared to the Reference. Results are reported in Table 2. Surprisingly, the use of ATH leads to a significant improvement of the thermal ageing characteristics. As an example, the time to failure for the formulations filled with ATH2 and W12 (Reference 2 and Reference 3) is more than 8 times longer than the Reference. The reasons for such an improvement remain unclear.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

1. A hardenable epoxy resin composition which is suitable for the production of an electrical insulation with improved thermal ageing properties, wherein said hardenable epoxy resin composition comprises an epoxy resin, a hardener, an inorganic filler composition, and a coupling agent for improving the bonding between the polymer matrix and the filler, and optionally further additives, wherein,
(i) the filler composition comprises silica and aluminum trihydride (ATH) at a ratio of silica:ATH from 10:1 to 1:10;
(ii) the average particle size distribution of the silica is within the range of from 100 μm-0.5 μm;
(iii) the average particle size distribution of ATH is below 10 μm, preferably within the range of from 10.0 μm-0.5 μm; and
(iv) the filler composition is present in an amount within the range of 20-80% by weight, calculated to the total weight of the insulating composition, and wherein
(v) the coupling agent is present preferably within the range of 0.1%-10% by weight, calculated to the total weight of the insulating composition.

2. A composition according to claim 1, wherein said composition comprises further at least a filler material which is different from silica and ATH, a curing agent for enhancing the polymerization of the epoxy resin with the hardener, at least a wetting/dispersing agent, at least one plasticizer, antioxidants, light absorbers, as well as further additives used in electrical applications.

3. A composition according to claim 1, wherein said filler composition comprises silica and aluminum trihydrate (ATH) at a ratio of silica:ATH from 10:1 to 1:10; preferably at a ratio from 5:1 to 1:5, preferably at a ratio of about 2:1 to 1:2, and most preferably at a ratio of about 1:1.

4. A composition according to claim 1, wherein the filler composition further comprises a known inorganic filler which is different from silica and ATH in a weight ration of up to 50% by weight, preferably up to 30% by weight, and preferably up to 15% by weight, calculated to the weight of the ATH present.

5. A composition according to claim 2, wherein the average particle size distribution of silica and of said optional filler which is different from silica and ATH is within the range of from 100 μm-5 μm, preferably within the range of from 50 μm-5 μm, and preferably at about 10 μm, and wherein preferably at least 70% of the particles, preferably at least 80% of the particles, and preferably at least 90% of the particles have a particle size within said range.

6. A composition according to claim 1, wherein the average particle size distribution of ATH is within the range of from 5.0 μm-0.5 μm, and preferably within the range of from 4.0 μm-1.0 μm, and wherein preferably at least 70% of the particles, preferably at least 80% of the particles, and preferably at least 90% of the particles have a particle size within said range.

7. A composition according to claim 1, wherein the filler composition is present in an amount within the range of 20-80% by weight, preferably within the range of 40-70% by weight, and preferably within the range of 50-65% by weight, calculated to the total weight of the insulating composition.

8. A composition according to claims 1, wherein the coupling agent for improving the bonding between the polymer matrix and the filler is selected from the group comprising silanes, siloxanes, titanate compounds, zirconate compounds, aluminate compounds, functionalized copolymers and organic acid-chromium chloride coordination complexes, preferably selected from silanes and siloxanes, preferably selected from silanes.

9. A composition according to claim 1, wherein the coupling agent is present within the range of about 0.1%-10.0% by weight, preferably 0.1%-4.0% by weight, preferably 0.1%-2.0% by weight, and preferably within the range of 0.4%-1.0% by weight, calculated to the total weight of the insulating composition.

10. A composition according to claim 8, wherein the silane corresponds to the chemical formula:
(R)₃Si(reactive group),
wherein
R independently of each other is an optionally substituted alkyl radical having from 1 to 8 carbon atoms, (C₁-C₄-alkyl)aryl, or aryl; or an alkoxy radical having from 1-8 carbon atoms; and the reactive group is selected from hydroxyl, hydrosilyl, carboxyl, alkyl-epoxy, vinyl, allyl or an amine or an alkylene-amine group, and preferably is a alkyl-epoxy group.

11. A composition according to claim 10, wherein the silane is a trialkylsilane carrying a reactive group is a trimethylsilane; a dimethylphenylsilane or a phenyldimethylsilane; and the alkoxysilane carrying a reactive group has one, two or three alkoxy groups, preferably is a methyldimethoxysilane or a trimethoxysilane.

12. A composition according to claim 8, wherein the siloxane coupling agent is selected from the group comprising polydimethylsiloxanes which preferably carry reactive groups, preferably selected from hydroxyl, hydrosilyl, carboxyl, alkyl-epoxy, vinyl or allyl or an amine or an alkylene-amine group, and preferably is an alkyl-epoxy functionality.

13. A composition according to claim 8, wherein the coupling agent comprises a compound, or a mixture of compounds, of the general formula (I) or formula (II): 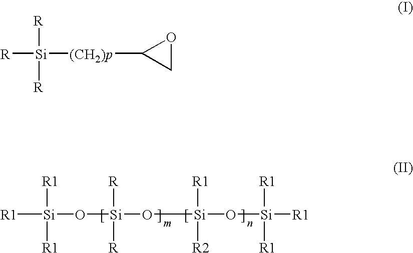
in which
R independently of each other is an optionally substituted alkyl radical having from 1 to 8 carbon atoms, (C₁-C₄-alkyl)aryl, or aryl; or an alkoxy radical having from 1-8 carbon atoms;
R₁ independently at each occurrence has one of the definitions of R or R₂, it being possible for two terminal substituents R₁ attached to different Si atoms, being taken together to be an oxygen atom (=cyclic compound);
p is 1, 2, 3 or 4, preferably 1 or 2;
R₂ has one of the definitions of R, or is hydrogen, hydroxyalkyl or —CH₂—[CH—CH₂(O)] or —(CH₂)₂—[CH—CH₂(O)]; vinyl or allyl; —NH₂ or —(CH₂)ₚNH₂; preferably —CH₂—[CH—CH₂(O)] or —(CH₂)₂—[CH—CH₂(O)];
m is on average from zero to 5000;
n is on average from one to 100;
the sum of [m+n] for non-cyclic compounds being at least 20, and the sequence of the groups —[Si(R)(R)O]— and —[Si(R₁)(R₂)O]— in the molecule being arbitrary.

14. Composition according to claim 13, wherein the coupling agent comprises a compound or a mixture of compounds of the formula (I), wherein R is methyl or methoxy and p is 1 or 2, preferably 1, preferably the compound 3-glycidoxypropyltrimethoxysilane and/or 3-glycidoxypropyldimethoxymethylsilane.

15. Composition according to claim 13, wherein the coupling agent comprises a compound or a mixture of compounds of the formula (II), preferred is the compound of the formula (II), wherein R independently of each other is an unsubstituted alkyl radical having from 1 to 4 carbon atoms or phenyl, preferably methyl; R₂ is —CH₂—[CH—CH₂(O)] or —(CH₂)₂—[CH—CH₂(O)]; m is on average from 20 to 5000, preferably 20 to 100; n is on average from 2 to 50, preferably 2 to 10; the sum of [m+n] for non-cyclic compounds being on average in the range from 22 to 5000, preferably 22 to 100, and the sequence of the groups —[Si(R)(R)O]— and —[Si(R₁)(R₂)O]— in the molecule being arbitrary.

16. Composition according to claim 13, wherein the coupling agent comprises a cyclic compound or a mixture of cyclic compounds of formula (II) having 4-12, and preferably 4-8, —[Si(R)(R)O]— units or —[Si(R₁)(R₂)O]— units or a mixture of these units, and preferably wherein the compound contains at least one —[Si(R₁)(R₂)O]— units wherein R₂ is —CH₂—[CH—CH₂(O)] or —(CH₂)₂—[CH—CH₂(O)].

17. Composition according to claim 1, wherein the filler composition comprises at least one known inorganic filler which is different from silica and ATH and which is selected from the group comprising silicon dioxide (SiO₂), aluminium oxide, xonolite, magnesium hydroxide, ground natural stones, ground natural minerals (e.g. ground sand) and synthetic minerals derived from silicates.

18. Composition according to claim 1, wherein the filler composition, which optionally is coated, has a density of said filler within the range of 60% to 80%, compared to the real density of the non-porous filler, preferably with a surface which is higher than 20 m²/g (BET m²/g) and preferably higher than 30 m²/g (BET) and preferably is within the range of 30 m²/g (BET) to 300 m²/g (BET), preferably within the range of 40 m²/g (BET) to 60 m²/g (BET).

19. Composition according to claim 1, wherein the epoxy resin is an known aromatic and/or cycloaliphatic compound.

20. Composition according to claim 1, wherein the hardener is used in concentrations within the range of 0.2 to 1.2, preferably within the range of 0.2 to 0.4, equivalents of hardening groups.

21. Composition according to claim 1, wherein the composition further comprises at least one of the following additives: a curing agent for enhancing the polymerization of the epoxy resin with the hardener, a wetting/dispersing agent, a plasticizer, an antioxidant, a light absorber, any further additive used in electrical applications.

22. Composition according to claim 21, wherein the wetting/dispersing agent is selected from the group comprising surface activators; reactive diluents, preferably epoxy-containing or hydroxyl-containing reactive diluents; thixotropic agents or resinous modifiers, preferably selected from the group comprising cresylglycidylether, diepoxyethyl-1,2-benzene, bisphenol A, bisphenol F and the diglycidylethers thereof, diepoxydes of glycols and of polyglycols, preferably neopentylglycol-diglycidylether or trimethylolpropane-diglycidylether or organic copolymers containing acidic groups, preferably having an acid value of about 129 mg KOH/g).

23. Composition according to claim 22, wherein the wetting/dispersing agent is present in amounts of 0.5% to 1.0% based on the filler weight.

24. Method of making a composition according to claim 1, characterized by mixing all the components, optionally under vacuum, in any desired sequence and curing the mixture by heating, preferably by adding the hardener and the curing agent separately before curing, whereby the curing temperature is preferably within the range of 50° C. to 280° C., preferably within the range of 100° C. to 200° C.

25. The use of the composition according to claim 1 for the production of an electrical insulation, especially in the field of impregnating electrical coils and in the production of electrical components such as transformers, bushings, insulators, switches, sensors, converters and cable end seals.

26. A hardened epoxy resin composition made from a hardenable epoxy resin composition according to claim 1, in the form of an electrical insulation.

27. An electrical article containing an electrical insulation system according claim 26.

28. Shaped articles comprising the hardened epoxy resin composition in the form of an electrical insulation according to claim 26, such as electrical coils, of electrical components, preferably transformers, bushings, insulators, switches, sensors, converters and cable end seals, said articles having been made by using vacuum casting or automated pressure gelation (APG) manufacturing processes.

29. Composition according to claim 17, wherein the filler composition, which optionally is coated, has a density of said filler within the range of 60% to 80%, compared to the real density of the non-porous filler, preferably with a surface which is higher than 20 m²/g (BET m²/g) and preferably higher than 30 m²/g (BET) and preferably is within the range of 30 m²/g (BET) to 300 m²/g (BET), preferably within the range of 40 m²/g (BET) to 60 m²/g (BET).

30. Composition according to claim 2, wherein the composition further comprises at least one of the following additives: a curing agent for enhancing the polymerization of the epoxy resin with the hardener, a wetting/dispersing agent, a plasticizer, an antioxidant, a light absorber, any further additive used in electrical applications.
